(19) United States
(12) Patent Application Publication
(10) Pub. No.: US 2010/0242944 A1
(43) Pub. Date: Sep. 30, 2010

(54) MULTI-BURNER HEAD

(75) Inventors: STEVE RICHARDSON, Randolph Center, VT (US); Mark T. Proffitt, Greeneville, TN (US); Kevin Groth, Johnson City, TN (US)

Correspondence Address: MCGUIREWOODS, LLP, 1750 TYSONS BLVD, SUITE 1800, MCLEAN, VA, 22102, US

(73) Assignee: Meco Corporation, Greeneville, TN (US)

(21) Appl. No.: 12/751,864

(22) Filed: Mar. 31, 2010

Related U.S. Application Data
(60) Provisional application No. 61/165,153, filed on Mar. 31, 2009.

(51) Int. Cl. A47J 37/07; F24C 3/08; F24C 3/10

(52) U.S. Cl. 126/25 B; 126/39 E

(57) ABSTRACT

A multi-burner system includes a horizontally elongated body structure having burner heads extending along an axis. Each burner head has a length along the axis greater than a width or height thereof and includes an inner chamber, a housing surrounding the inner chamber and holes formed on the housing to disperse gas externally from the inner chamber. The multi-burner system further includes a plurality of conduits connected to the body structure to convey the gas to the inner chamber of each burner head.

### CROSS REFERENCE TO PRIOR APPLICATIONS

This application claims a priority and benefit thereof from U.S. Provisional Application No. 61/165,153 filed on Mar. 31, 2009, which is hereby incorporated by reference for all purposes as if fully set forth herein.

### BACKGROUND OF THE DISCLOSURE

1. Field of the Disclosure

This disclosure is directed to a burner. More particularly, the invention is directed to a multi-burner head that may be fueled by natural gas, propane or the like.

2. Related Art

Outdoor barbeque grills are very popular and produced in a variety of configurations. Commonly, these grills are constructed to be self contained, small and portable. The grill includes a stand which supports a grill housing, such as a metal casing. The housing houses one or more separate burner heads and supporting racks. Generally, the housing includes a lid which may be opened to provide access to the interior, including the racks. The lid may be closed during cooking to retain the heat in the housing. Often, these grills are mounted on wheels to allow the user to easily move the grill when it is not in use. Such grills do not have great control of a grill temperature and are more costly to construct.

The disclosure is directed to the burner heads, particularly to an improved burner head configuration having greater controller of a grill temperature and configured to be less costly to construct.

### SUMMARY OF THE DISCLOSURE

According to an aspect of the disclosure, a multi-burner system includes a horizontally elongated body structure including burner heads extending along an axis, each burner head having a length along the axis greater than a width or height thereof and comprising an inner chamber, a housing surrounding the inner chamber and holes formed on the housing to disperse gas externally from the inner chamber, and conduits connected to the body structure to convey the gas to the inner chamber of each burner head.

The burner heads may be arranged in series in a horizontal direction to which the body structure is elongated. Each burner head may be horizontally elongated in the horizontal direction to which the body structure is elongated. The inner chambers of the burner heads may be isolated from each other. The conduits may be connected to the burner heads, respectively, to convey the gas to the inner chambers thereof, respectively.

The body structure may further include a flange formed around the burner heads. Each housing may include an upper wall structure protruding upwardly from the flange, and a lower wall structure protruding downwardly from the flange. The upper wall structure and the lower wall structure may be adjoined at the flange to form the inner chamber therebetween.

The upper wall structure may include a top wall having a substantially planar surface and an upper sidewall extending between the flange and the top wall. The holes may be formed at the upper sidewall. The lower wall structure may include a bottom wall having a substantially planar surfaces and a second sidewall extending between the flange and the bottom wall. The conduit may be connected to the bottom wall. The upper wall structure and the lower wall structure may be substantially symmetric with respect to the flange.

A grill may include a grill body and the multi-burner system. The grill may further include at least one of the first bracket configured to engage the multi-burner system to support the multi-burner system in the grill body, the second bracket configured to engage the multi-burner system and a fixture to support the fixture above the multi-burner system, and the third bracket configured to ignite the multi-burner system.

The first bracket may include two first brackets connected to the first and second ends of the multi-burner system, respectively. The second bracket and the at least one third bracket may be arranged between two neighboring burner heads.

According to another aspect of the disclosure, a multi-burner head may include a horizontally elongated body structure including burner heads surrounding inner chambers, respectively, each burner head having a substantially flat top surface, a side surface and a bottom surface to separate the inner chamber from each other, holes for dispersing gas externally from the side surface of each burner head, and conduits connected to the burner heads, respectively, for conveying the gas to the inner chambers thereof.

The inner chambers may be arranged in series in a horizontal direction to which the body structure is elongated.

The body structure may include an upper body including the first recesses and the first flange surrounding the first recesses, and a lower body and comprising the second recesses and the second flange surrounding the second recesses and connected to the first flange. The chambers may be formed by overlapping the first recesses and the second recesses, respectively.

The holes may be formed on portions of the upper body covering the plurality of first recesses. The conduits may be connected to portions of the lower body covering the second recess, respectively. The upper wall structure and the lower wall structure may be substantially symmetric with respect to the first and second flanges.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a perspective view of a multi-burner head constructed according to the principles of the disclosure;

FIG. 2 shows a top view of the multi-burner head of FIG. 1;

FIG. 3 shows a front view of the multi-burner head of FIG. 1;

FIG. 4 shows a side view of the multi-burner head of FIG. 1;

FIG. 5 shows a partial enlarged perspective view of the multi-burner head of FIG. 1;

FIG. 6 shows a partial enlarged front view of the multi-burner head of FIG. 1;

FIG. 7 shows a bottom view of an upper main body of the multi-burner head of FIG. 1, constructed according to the principles of the disclosure;

FIG. 8 shows a top view of a lower main body of the multi-burner head of FIG. 1, constructed according to the principles of the disclosure;

FIG. 9 shows a perspective view of an upper bracket of the multi-burner head of FIG. 1, constructed according to the principles of the disclosure; and

FIG. 10 shows a perspective view of a crossover bracket of the multi-burner head of FIG. 1, constructed according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

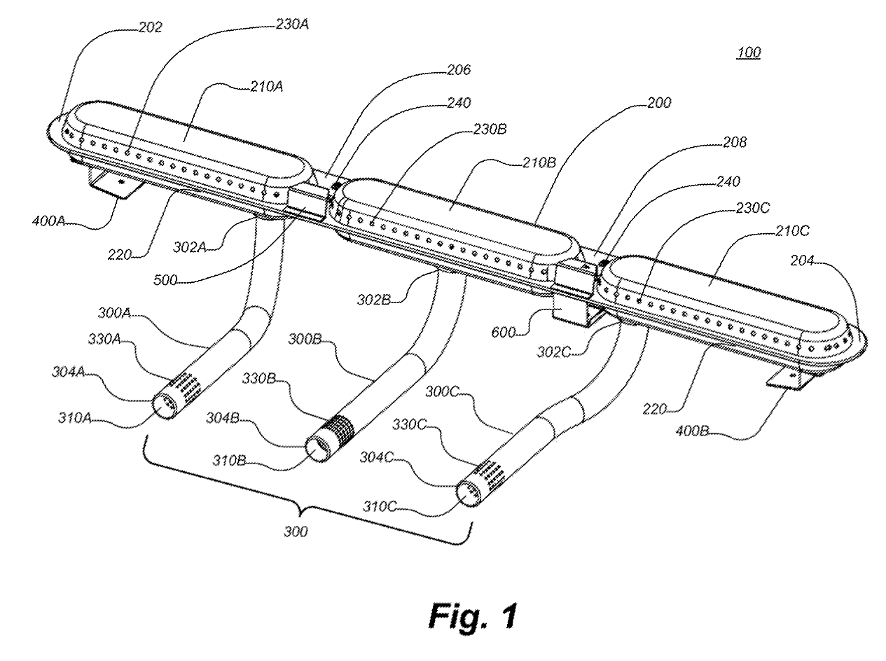

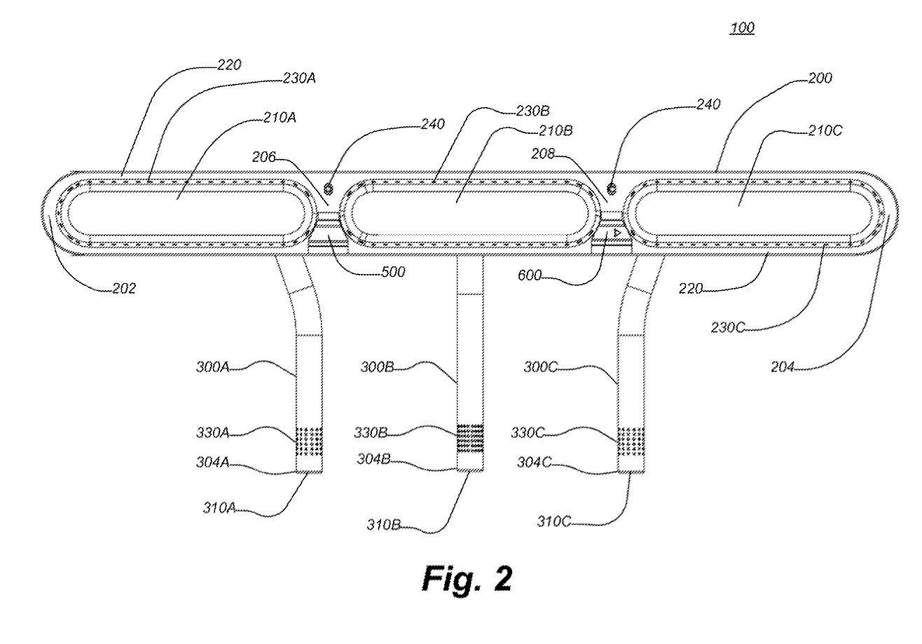

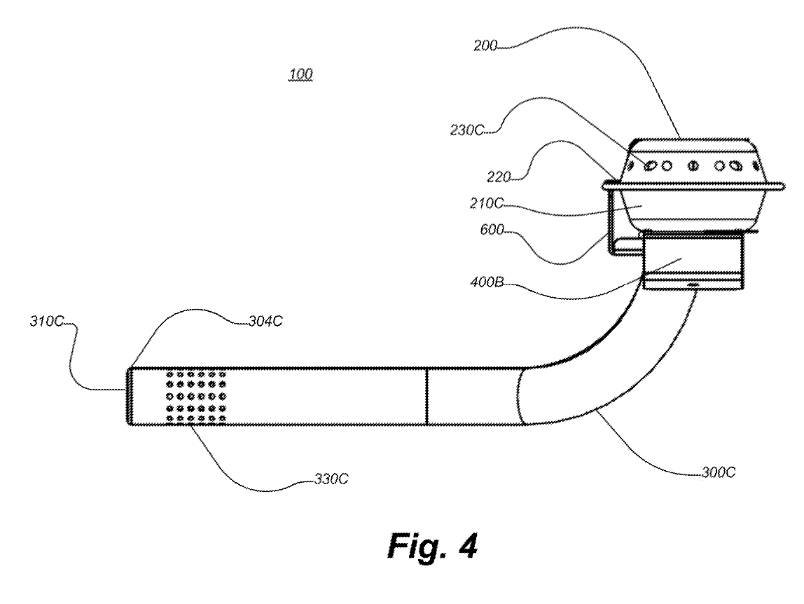

FIG. 1 shows a perspective view of a multi-burner head 100 constructed according to the principles of the disclosure. FIGS. 2, 3 and 4 show a top view, a front view and a side view of the multi-burner head 100, respectively. Referring to FIGS. 1, 2, 3 and 4 concurrently, the multi-burner head 100 may include a main body 200, one or more conduits 300 connected to the main body 200 and/or the like. As shown in FIG. 2, the main body 200 may have a horizontally elongated shape which continuously extends from one end portion 202 to another end portion 204 thereof. Other shapes are also contemplated for the main body 200, for example, a triangular, square, rectangular, circular, elliptical shape or the like. Further, the main body 200 may have one or more bent or curved portions and may be discontinuous at one or more portions thereof. As shown in FIGS. 1 and 2, the end portions 202, 204 of the main body 200 may have a rounded shape. Other shapes are also contemplated, such as, e.g., an angular shape or a combination of circular and angular shapes.

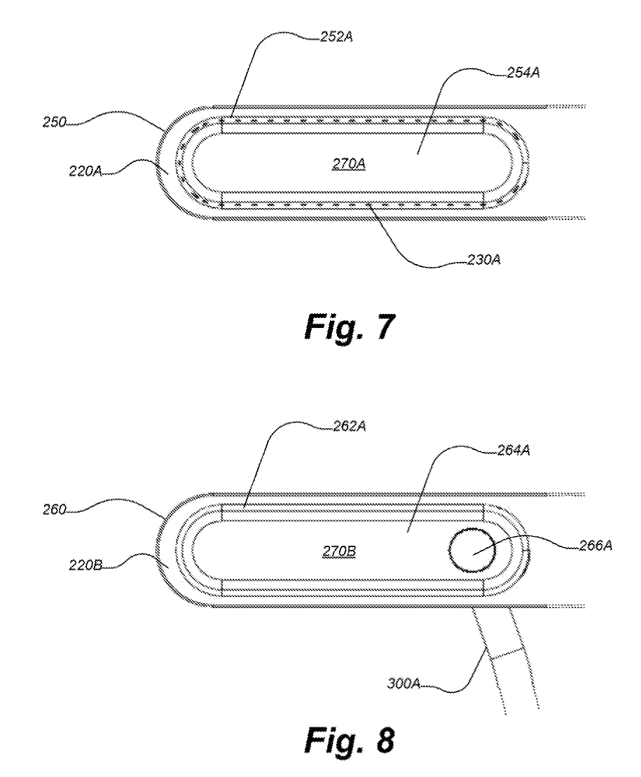

The main body 200 may include a plurality of burner heads 210, such as, e.g., a first burner head 210A, a second burner head 210B, a third burner head 210C and/or the like. Fewer or more burner heads 210 are also contemplated. Each of the first, second and third burner heads 210A, 210B, 210C may have an inner chamber (not shown), which is described below in detail with reference to FIGS. 7 and 8. Further, the first, second and third burner heads 210A, 210B, 210C may have a plurality of holes 230A, 230B, 230C, respectively, to disperse or eject fuel gas, such as, e.g., natural gas, propane, butane and/or the like, externally from the inner chambers thereof, respectively. The main body 200 may also include a flange 220 which may surround the burner heads 210A, 210B, 210C. Thus, the flange 220 may occupy a gap portion 206 between the first and second burner heads 201A, 210B and another gap portion 208 between the second and third burner heads 210B, 210C. The main body 200 may further include one or more holes 240 to provide secondary air flows to flames when the multi-burner head 100 is ignited. For example, the main body 200 may optionally include two holes 240 arranged on the flange 220 at the gap portions 206, 208.

Referring to FIG. 2, the first, second and third burner heads 210A, 210B, 210C may have the substantially same horizontally elongated shape with rounded ends. Other shapes are contemplated for the first, second and third burner heads 210A, 210B, 210C. Further, the first, second and third burner heads 210A, 210B, 210C may have different shapes depending on the configuration, such as, e.g., a shape, a length, a width and/or the like, of the main body 200. The first, second and third burner heads 210A, 210B, 210C may be arranged in series in a direction to which the main body 200 is elongated, with the gap portions 206, 208 therebetween. For example, as shown in FIG. 1, the first and third burner heads 210A, 210C may be located near the end portions 202, 204 of main body 200, respectively, and the second burner head 210B may be arranged between the first and third burner heads 210A, 210C. The arrangement of the burner heads 210A, 210B, 210C may vary depending on the configuration of the main body 200. For example, in a wider and shorter main body 200, the burner heads 210A, 210B, 210C may be arranged in parallel in a direction perpendicular or diagonal to the direction the main body 200 is elongated.

The conduits 300 may be connected to the main body 200 to convey the fuel gas to the inner chambers of the burner heads 210. The number of the conduits 300 may be the same as the number of the burner heads 210. For example, the multi-burner head 100 may include three conduits, i.e., first, second and third conduits 300A, 300B, 300C, that are connected to the first, second and third burner heads 210A, 210B, 210C, respectively. The separate conduits 300A, 300B, 300C may allow for discrete control of fuel gas to each of the burner heads 210. This may result in greater control of cooling temperature and heat distribution. Alternatively, the number of the conduits 300 and the number of the burner heads 210 may be different. For example, the multi-burner head 100 may include a single conduit and the main body 200 may include one or more manifold pipes or other distribution system that distributes the gas from the conduit 300 to the burner heads 210A, 210B, 210C.

As shown in FIGS. 1, 2, 3 and 4, the conduits 300A, 300B, 300C may be connected to a bottom portion of the first, second and third burner heads 210A, 210B, 210C, respectively, such that the fuel gas, which is typically buoyant in air, may be more efficiently and evenly dispersed from the inner chambers via the holes 230A, 230B, 230C. Alternatively, the conduits 300A, 300B, 300C may be connected to a side or top portion of the first, second and third burner heads 210A, 210B, 210C, respectively, if necessary.

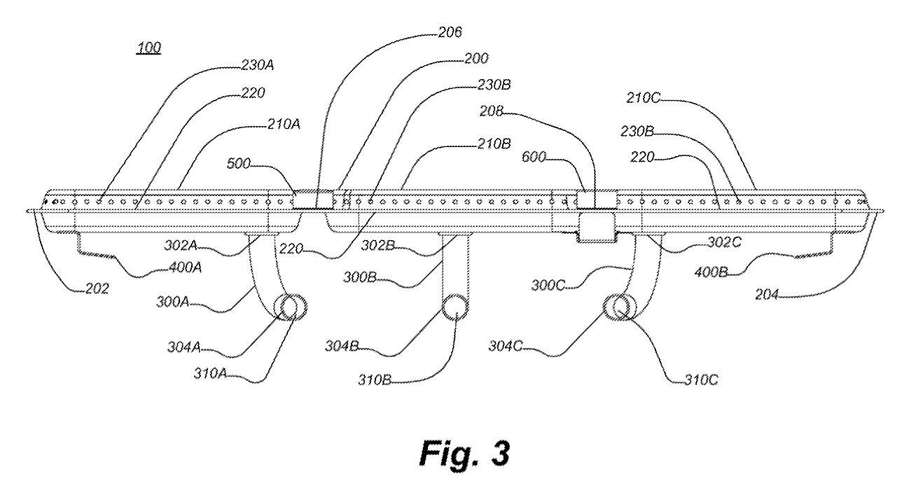

As shown in FIG. 3, one end 302A of the first conduit 300A may be connected to the bottom of the first burner head 210A. The other end 304A of the first conduit 300A may have an opening 310A. The end 304A may be connected directly to a fuel source (not shown), such as, e.g., a gas tank, a gas outlet and/or the like, or indirectly connected to the fuel source via a manifold pipe and/or tube and/or the like. The first conduit 300A may have one or more bent portions to direct the fuel gas from the opening 310A to the inner chamber of the first burner head 210A. For example, as shown in FIG. 3, the first conduit 300A may be vertically bent upwardly such that the end 302A thereof may be connected to the bottom of the first burner head 210A.

The first conduit 300A may further have a plurality of apertures 330A to receive air from outside the first conduit 300A and mix the air with the fuel gas conveyed via the opening 310A. The apertures 330A may be formed near the end 304A of the first conduit 300A. Further, the first conduit 300A may be configured to provide a Venturi effect. For example, one or more portions of the first conduit 300A may be constricted (not shown) to cause decreased pressure in the first conduit 300A, which may provide suction that may draw air from outside the first conduit 300A and mix the air with the fuel gas conveyed thereto via the opening 310A. The constricted area may be formed near the apertures 330A. The second and third conduits 300B, 300C may be configured identical or substantially similar to the first conduit 300A. However, as shown in FIG. 2, the first and third conduits 300A, 300B may also be horizontally bent outwardly to direct the fuel gas from the openings 310A, 310C to the inner chambers of the first and third burner heads 210A, 210C, respectively.

Further, the multi-burner head 100 may include one or more brackets, such as, e.g., one or more lower brackets 400, one or more upper brackets 500, one or more crossover brackets 600, and/or the like. The lower bracket 400 may be configured to support the main body 200. For example, the lower bracket 400 may be affixed to the main body 200 and configured to engage one or more underlying fixtures, such as, e.g., a grill body (not shown) or the like, to support the main body 200 thereon. The lower bracket 400 may be affixed to the bottom of the main body 200. For example, as shown in FIGS. 1 and 3, the multi-burner head 100 may include two lower brackets 400A, 400B affixed to the bottom of the main body 200 near the end portions 202, 204, respectively. Fewer or more lower brackets 400 may be used to support the main body 200 on the underlying fixture.

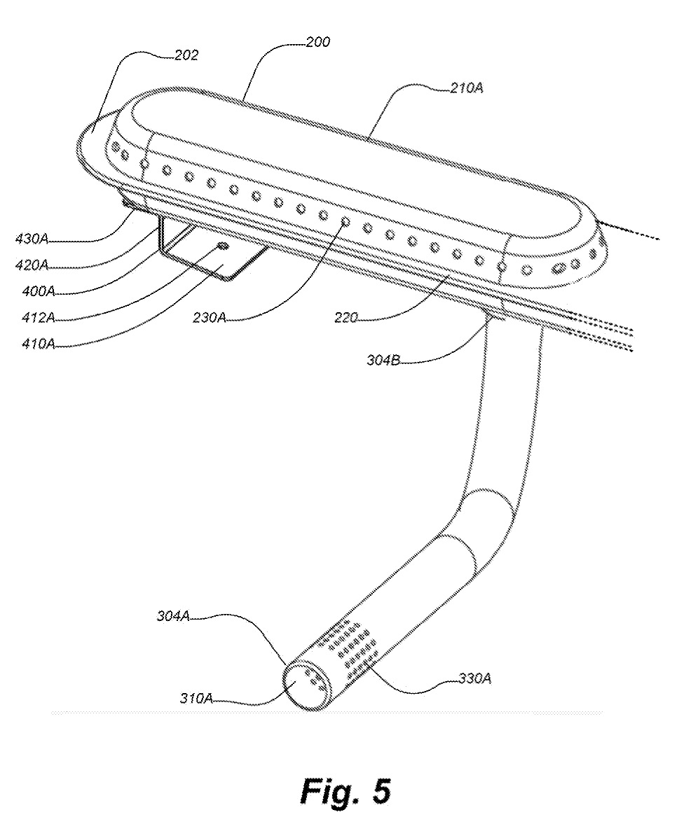

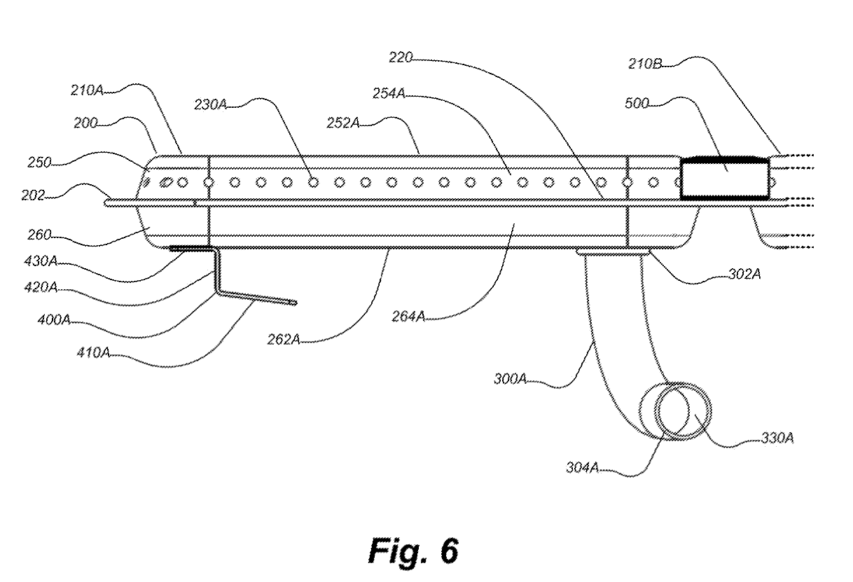

As shown in FIGS. 5 and 6, which show partial enlarged perspective and front views of the multi-burner head 100, respectively, the lower bracket 400A may include a lower surface section 410A, a vertical section 420A, an upper surface section 430A and/or the like. The lower surface section 410A may be configured to engage one or more underlying fixtures (not shown), such as, e.g., a bottom panel of a grill body or the like. The lower surface section 410A may include a hole 412A, though which a fastener (not shown), such as, e.g., a bolt or the like, may be inserted into to fasten the lower surface section 410A and the underlying fixture together. The underlying fixture may have another hole (not shown) overlapping the hole 412A and a nut (not shown) may be used to fasten the bolt with the lower surface section 410A and the underlying fixture therebetween. The vertical section 420A may extend from the lower surface section 410A to the upper surface section 430A. The vertical section 420B may provide elastic/rigid support and convey a supporting force from the lower surface section 410A to the upper surface section 430A. The upper surface section 430A may be affixed to the bottom of the main body 200. For example, the upper surface section 430A may be affixed to the bottom of the first burner head 210A. The upper surface section 430A may convey the supporting force from the bottom surface section 410A, elastic/rigid support from the vertical section 420A and/or the like, to the main body 200. The lower bracket 400B may be configured similarly or identical to the lower bracket 400A.

The upper bracket 500 may be configured to support one or more overlying fixtures (not shown), such as, e.g., a cooking grid, a warming rack and/or the like, that are located above the main body 200. The upper bracket 500 may be affixed to the top of the main body 200. For example, the upper bracket 500 may be affixed on the flange 220 at the gap portion 206 between the first and second burner heads 210A, 210B, as shown in FIGS. 1, 2 and 3. More than one upper bracket 500 may be arranged at different locations. For example, two upper brackets 600 may be arranged at the gap portions 206, 208.

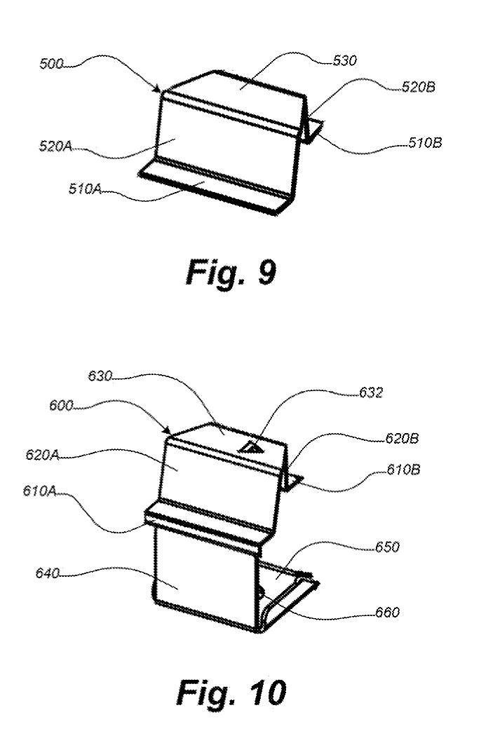

FIG. 9 shows a perspective view of the upper bracket 500, constructed according to the principles of the disclosure. The upper bracket 500 may include a pair of foot sections 510A, 510B, a pair of vertical sections 520A, 520B, an upper surface section 530 and/or the like. The foot section 510B and the vertical section 520B may be narrower than their counterparts (i.e., the foot section 510A and the vertical section 520A), respectively, because the gap portion 206 may become narrower as advancing from an edge portion to a middle portion thereof by the rounded boundaries of the first and second burner heads 210A, 210B.

At least one of the foot sections 510A, 510B may be affixed on the flange 220 to convey a supporting force from the flange 220 to the overlying fixture via the vertical sections 520A, 520B and the upper surface section 530. The wider foot section 510A may be arranged on the edge portion of the gap portion 206 while the narrower foot section 510B may be arranged on the middle portion of the gap portion 206. The vertical sections 520A, 520B may extend upwardly from the foot sections 510A, 510B, respectively. The vertical sections 520A, 520B may be configured to convey the supporting force from the foot sections 510A, 510B, respectively, and provide elastic/rigid support to the overlying fixture via the upper surface section 530. The upper surface section 530 may extend between the vertical sections 520A, 520B. The upper surface section 530 may convey the supporting force from the foot sections 510A, 510B, the elastic/rigid support from the vertical sections 520A, 520B and/or the like, to the overlying fixture.

The crossover bracket 600 may be configured to ignite the multi-burner head 100. The crossover bracket 600 may be further configured to provide gas flows between the burner heads 210A, 210B, 210C. As shown in FIGS. 1, 2 and 3, the crossover bracket 600 may be affixed to the flange 220 at the gap portion 208 between the second and third burner heads 210B, 210C. However, the crossover bracket 600 may be arranged at a different location. For example, the crossover brackets 600 may be arranged at the gap portions 206.

FIG. 10 shows a perspective view of the crossover bracket 600 of the multi-burner head 100 of FIG. 1, constructed according to the principles of the disclosure. The crossover bracket 600 may include a pair of foot sections 610A, 610B, a pair of upper vertical sections 620A, 620B, an upper surface section 530, a lower vertical section 640, a lower surface section 650 and/or the like. Similar to the upper bracket 500 shown in FIG. 9, the foot section 610B and the upper vertical section 620B may be narrower than the foot section 610A and the upper vertical section 620A, respectively, because the gap portion 208 becomes narrower as advancing from an edge portion to a middle portion thereof by the rounded boundaries of the second and third burner heads 210B, 210C.

The lower surface section 650 may include a hole 660, though which a wire (not shown) may extend from an ignition source, such as, e.g., a battery or the like. The lower vertical section 640 may extend from the lower surface section 650 to the foot section 610A to convey a supporting force from the underlying fixture to the flange 200 via the foot section 610A. Similar to the upper bracket 500 shown in FIG. 9, at least one of the foot sections 610A, 610B may be affixed to the flange 220. The foot section 610A may be arranged on the edge portion of the gap portion 208 while the foot section 610B may be arranged on the middle portion of the gap portion 208. The upper vertical sections 620A, 620B may extend upwardly from the foot sections 610A, 610B, respectively. The upper surface section 630 may extend between the upper vertical sections 620A, 620B. The upper surface section 630 may include a hole 632 for optimizing an ignition gap and providing a gas flow for ignition. The hole 632 may be formed by creating a tab on the upper surface section 630 and turning down the tab.

The main body 200 shown in FIGS. 1-6 may be formed by assembling two or more body parts. For example, the main body 200 may be an assembly of an upper main body and a lower main body. FIG. 7 shows a partial bottom view of an upper main body 250 and FIG. 8 shows a partial top view of a lower main body 260, constructed according to the principles of the disclosure. In FIG. 7, the upper main body 250 may include an upper flange 220A, an upper sidewall 252A, an upper wall 254A and/or the like. The upper sidewall 252A may extend upwardly from the upper flange 220A and surround the upper wall 254A, thereby forming an upper recess 270A. The holes 230A may be formed on the upper sidewall 252A.

The lower main body 260 may be configured symmetrically to the upper main body 250. For example, in FIG. 8, the lower main body 260 may include a lower flange 220B, a lower sidewall 262A, a lower wall 264A and/or the like. The lower sidewall 262A may extend downwardly from the lower flange 220B and surround the lower wall 264A, thereby forming a lower recess 270B. The lower main body 260 may further include a bottom hole 266A, which may be connected to the conduit 300A. By aligning the upper and lower main bodies 250, 260, the upper recess 270A and the lower recess 270B may be overlapped and combined to form the inner chamber for the first burner head 210A (see FIGS. 5 and 6). The second and third burner heads 210B, 210C may also be formed by conjoining the upper and lower main bodies 250, 260 together. The upper and lower main bodies 250 and 260 may be conjoined by welding the upper flange 220A and the lower flange 220B. Other joining methods are contemplates, such as, e.g., stamping, crimping and/or the like. Upon conjoining the upper and lower main bodies 250, 260, the inner chambers of the first, second and third burner heads 210A, 210B, 210C may be isolated from each other by the flange 220.

Although the upper and lower main bodies 250 and 260 may be symmetrically configured except for the holes 230A and the bottom hole 266A, the upper and lower main bodies 250 and 260 may be configured asymmetrically. For example, the lower sidewall 262A may be taller than the upper sidewall 252A, thereby increasing the volume of the lower recess 270B. Further, one of the upper and lower main bodies 250 and 260 may be substantially flat. For example, the lower main body 260 may be substantially flat and functions as a bottom cap for covering the upper recess 270A. Other configurations are also contemplated for the upper and lower main bodies 250 and 260.

Accordingly, the disclosure provides a multi-burner head with a greater temperature control and/or a construction that is less costly. Other advantages should also be apparent.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A multi-burner system comprising:
a horizontally elongated body structure comprising a plurality of burner heads extending along an axis, each burner head having a length along the axis greater than a width or height thereof and comprising an inner chamber, a housing surrounding the inner chamber and a plurality of holes formed on the housing to disperse gas externally from the inner chamber; and
a plurality of conduits connected to the body structure to convey the gas to the inner chamber of each burner head.

2. The multi-burner system of claim 1, wherein the plurality of burner heads are arranged in series in a horizontal direction to which the body structure is elongated.

3. The multi-burner system of claim 2, wherein each of the plurality of burner heads is horizontally elongated in the horizontal direction to which the body structure is elongated.

4. The multi-burner system of claim 1, wherein the inner chambers of the plurality of burner heads are isolated from each other.

5. The multi-burner system of claim 1, wherein the plurality of conduits are connected to the plurality of burner heads, respectively, to convey the gas to the inner chambers thereof, respectively.

6. The multi-burner system of claim 5, wherein the body structure further comprises a flange formed around the plurality of burner heads.

7. The multi-burner system of claim 6, wherein each housing comprises:
an upper wall structure protruding upwardly from the flange; and
a lower wall structure protruding downwardly from the flange,
wherein the upper wall structure and the lower wall structure are adjoined at the flange to form the inner chamber therebetween.

8. The multi-burner system of claim 7, wherein the upper wall structure comprises:
a top wall having a substantially planar surface; and
an upper sidewall extending between the flange and the top wall,
wherein the plurality of holes are formed at the upper sidewall.

9. The multi-burner system of claim 8, wherein the lower wall structure comprises:
a bottom wall having a substantially planar surfaces; and
a second sidewall extending between the flange and the bottom wall,
wherein the conduit is connected to the bottom wall.

10. The multi-burner system of claim 7, wherein the upper wall structure and the lower wall structure are substantially symmetric with respect to the flange.

11. A grill comprising a grill body and the multi-burner system of claim 1.

12. The grill of claim 11, further comprising at least one of:
at least one first bracket configured to engage the multi-burner system to support the multi-burner system in the grill body;
at least one second bracket configured to engage the multi-burner system and a fixture to support the fixture above the multi-burner system; and
at least one third bracket configured to ignite the multi-burner system.

13. The grill of claim 12, wherein the at least one first bracket comprises two first brackets connected to first and second ends of the multi-burner system, respectively.

14. The grill of claim 12, wherein the at least one second bracket and the at least one third bracket are arranged between two neighboring burner heads.

15. A multi-burner head, comprising:
a horizontally elongated body structure comprising a plurality of burner heads surrounding a plurality of inner chambers, respectively, each burner head comprising a substantially flat top surface, a side surface and a bottom surface to separate the inner chamber from each other;
a plurality of holes for dispersing gas externally from the side surface of each burner head; and
a plurality of conduits connected to the plurality of burner heads, respectively, for conveying the gas to the inner chambers thereof.

16. The multi-burner head of claim 15, wherein the plurality of inner chambers are arranged in series in a horizontal direction to which the body structure is elongated.

17. The multi-burner head of claim 15, wherein the body structure comprises:
an upper body comprising a plurality of first recesses and a first flange surrounding the plurality of first recesses; and
a lower body comprising a plurality of second recesses and a second flange surrounding the plurality of second recesses and connected to the first flange,
wherein the plurality of inner chambers are formed by overlapping the plurality of first recesses and the plurality of second recesses, respectively.

18. The multi-burner head of claim 17, wherein the plurality of holes are formed on portions of the upper body covering the plurality of first recesses.

19. The multi-burner head of claim 17, wherein the plurality of conduits are connected to a plurality of portions of the lower body covering the plurality of second recess, respectively.

20. The multi-burner head of claim 17, wherein the upper wall structure and the lower wall structure are substantially symmetric with respect to the first and second flanges.
